(19) United States
(12) Patent Application Publication
(10) Pub. No.: US 2024/0069312 A1
(43) Pub. Date: Feb. 29, 2024

(54) Zoom Lens Assembly

(71) Applicant: Apple Inc., Cupertino, CA (US)

(72) Inventors: Masaharu Hosoi, Cupertino, CA (US); Yoshikazu Shinohara, Cupertino, CA (US)

(21) Appl. No.: 18/071,259

(22) Filed: Nov. 29, 2022

Related U.S. Application Data
(60) Provisional application No. 63/401,495, filed on Aug. 26, 2022.

(51) Int. Cl. G02B 15/14; G03B 3/00

(52) U.S. Cl. CPC G02B 15/143503; G03B 3/00; G02B 5/04

(57) ABSTRACT

Various embodiments disclosed herein include zoom lens assemblies, as well as cameras and devices that incorporate these zoom lens assemblies. The zoom lens assemblies described herein include three lens groups, the first of which includes a light-folding element such as a prism. The second and third lens groups are moveable relative to the first lens group and relative to each other to change the focal length of the camera.

### CROSS-REFERENCE TO RELATED APPLICATION

This application is a nonprovisional and claims the benefit under 35 § U.S.C. 119(e) of U.S. Provisional Patent Application No. 63/401,495, filed Aug. 26, 2022, the contents of which are incorporated herein by reference as if fully disclosed herein.

### FIELD

This disclosure relates to lens assemblies for use in camera systems.

### BACKGROUND

Cameras continue to be an important feature of consumer electronics devices such as smartphones, tablets, and computers. Many devices now have multi-camera systems with two or more cameras that have lens assemblies with different focal lengths, and thus may capture images having different viewing angles and magnification. In some instances having multiple cameras saves space, cost, and/or complexity compared to having a single camera with a zoom lens that spans a given range of focal lengths. In other instances (such as at higher focal lengths), however, it may instead save space, cost, and/or complexity for a device to have a camera with a zoom lens instead of multiple cameras. Accordingly, it may be desirable to provide an imaging lens assembly with variable magnification capabilities that fit within the physical constraints imposed by small form factor cameras.

### SUMMARY

The present disclosure relates to zoom lens assemblies, as well as cameras and devices incorporating these zoom lens assemblies. Some embodiments as described herein are directed to a camera including an image sensor and a lens assembly, where the lens assembly has an optical axis and includes a first lens group having negative refractive power and including a first set of lens elements that is fixed in position on the optical axis. The lens assembly further includes a second lens group moveable along the optical axis between the first lens group and the image sensor, having positive refractive power, and including a second set of lens elements, as well as a third lens group moveable along the optical axis between the first lens group and the image sensor, having negative refractive power, and including a third set of lens elements. The camera further includes a set of actuators and a controller, where the controller is configured to control the set of actuators to move the second lens group and the third lens group along the optical axis to set a focal length of the lens assembly within a focal range of the lens assembly.

In some instances, the controller is also configured to control the set of actuators to move the third lens group along the optical axis while maintaining a position of the second lens group to focus the camera. In some instances, the first lens group includes a light-folding element configured to receive light from an object side of the lens assembly and redirect the light along the optical axis. In some of these variations, the first set of lens elements comprises a first lens element positioned immediately adjacent the light-folding element. An f-number of the lens system may be less than or equal to 3.0 across the focal range. In some of these variations, the f-number of the lens system is between f/2.2 and f/3.0 across the focal range. Additionally or alternatively, the focal range includes at least a range of 35 mm equivalent focal lengths including 72 mm and 108 mm.

Other variations as described are directed to a camera that includes an image sensor and a lens assembly having an optical axis, where the lens assembly includes a first lens group having negative refractive power and including a first set of lens elements that is fixed in position on the optical axis. The lens assembly also includes a second lens group immediately adjacent the first lens group, moveable along the optical axis, having positive refractive power, and including a second set of lens elements, and a third lens group immediately adjacent the first lens group, moveable along the optical axis, having negative refractive power, and including a third set of lens elements.

In some of these variations, the first lens group includes a light-folding element configured to receive light from an object side of the lens assembly and redirect the light along the optical axis, and the first set of lens elements comprises a first lens element positioned immediately adjacent the light-folding element. In some of these variations, the first set of lens elements includes a second lens element immediately adjacent to the first lens element of the first set of lens elements, the first set of lens elements comprises a third lens element immediately adjacent to the second lens element of the first set of lens elements, and the third lens element has negative refractive power.

Additionally or alternatively, the second set of lens elements includes a first lens element having positive refractive power and a second lens element having negative refractive power. In some of these variations, the first lens element of the second set of lens elements is immediately adjacent the first lens group. The second lens group may include an aperture layer defining an aperture. In some of these variations, the aperture layer is positioned between the first set of lens elements and the second set of lens elements.

Yet other embodiments are directed to a lens assembly having an optical axis including a first lens group having negative refractive power, a second lens group moveable along the optical axis and having positive refractive power, and a third lens group moveable along the optical axis and having negative refractive power. The first lens group includes a light-folding element and a first lens element having positive refractive power and fixed in position on the optical axis, the second lens group includes a first lens element having positive refractive power and immediately adjacent the first lens group, and the third lens group includes a first lens element having positive refractive power and immediately adjacent the second lens group.

In some instances, a thickness ratio of the first lens element of the third lens group is greater than 0.10, wherein the thickness ratio is a ratio of a thickness of the first lens element to a total optical stack length of the lens assembly. In some of these variations, the thickness ratio of the first lens element of the third lens group is greater than or equal to 0.15. Additionally or alternatively, the third lens group includes a second lens element having negative refractive power, and the first lens element of the third lens group is positioned between the second lens element of the third lens group and the second lens group. The second lens group may include an aperture layer defining an aperture. In some of these variations, the aperture layer is positioned between the first set of lens elements and the second set of lens elements.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A illustrates a device as described herein having a camera with a zoom lens assembly as described herein. FIG. 1B depicts exemplary components of the device of FIG. 1A.

FIG. 1C illustrates the camera with the zoom lens assembly of FIG. 1A.

FIG. 2A illustrates an embodiment of a camera having a zoom lens assembly having a plurality of lens groups as described herein. FIGS. 2B-2D depict different configurations of the lens assembly of FIG. 2A that have different focal lengths.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

Directional terminology, such as “top”, “bottom”, “upper”, “lower”, “front”, “back”, “over”, “under”, “above”, “below”, “left”, “right”, “vertical”, “horizontal”, etc. is used with reference to the orientation of some of the components in some of the figures described below, and is not intended to be limiting. Because components in various embodiments can be positioned in a number of different orientations, directional terminology is used for purposes of illustration only and is in no way limiting. The directional terminology is intended to be construed broadly, and therefore should not be interpreted to preclude components being oriented in different ways. Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

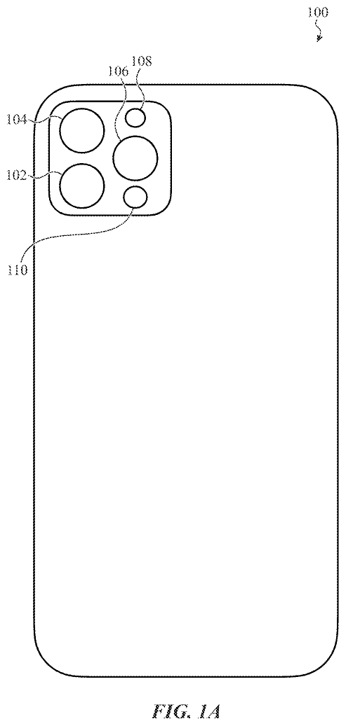

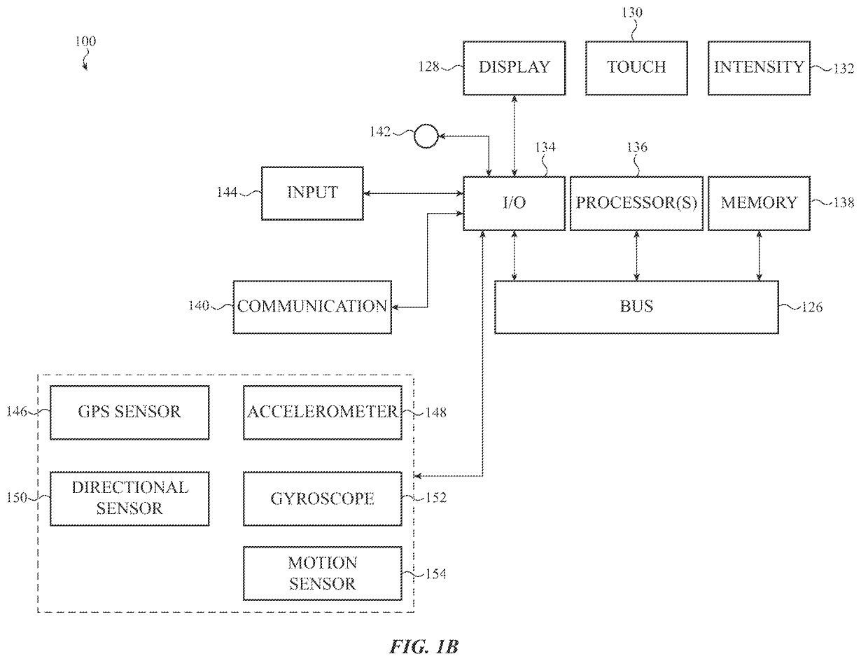

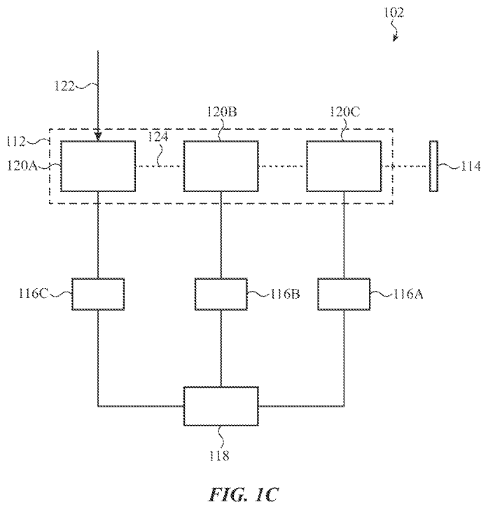

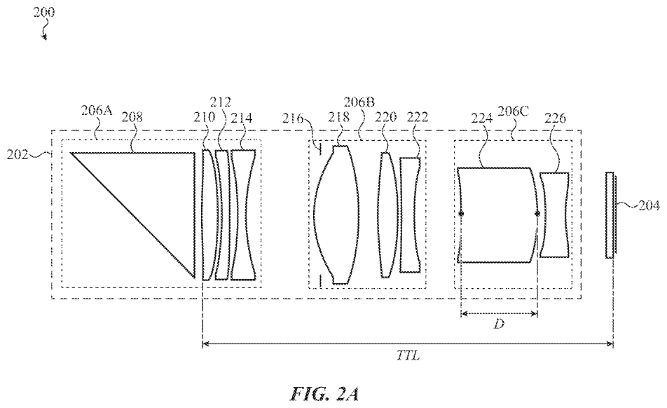

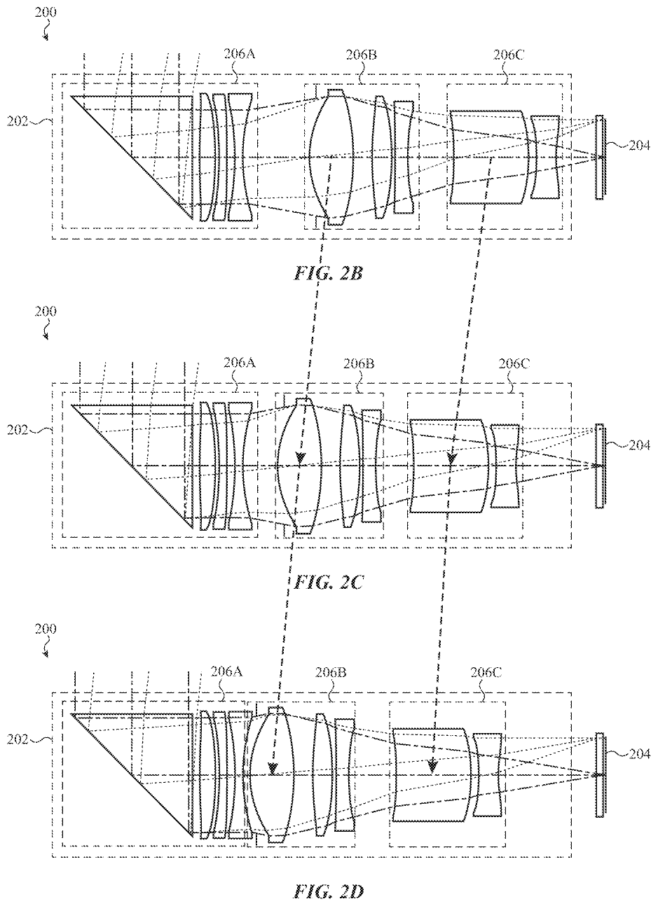

The following disclosure relates to zoom lens assemblies, as well as cameras and devices that incorporate these zoom lens assemblies. The zoom lens assemblies described herein include three lens groups, the first of which includes a light-folding element such as a prism. The second and third lens groups are moveable relative to the first lens group and relative to each other to change the focal length of the camera. These and other embodiments are discussed below with reference to FIGS. 1A-2D. However, those skilled in the art will readily appreciate that the detailed description given herein with respect to these Figures is for explanatory purposes only and should not be construed as limiting.

The zoom lens assemblies described herein may be incorporated into a camera, thereby providing a camera with zoom capabilities. This camera in turn may be incorporated into an electronic device such as a phone, tablet, computer, or the like. FIG. 1A depicts an example device 100 as described herein. As shown there, the device 100 includes a first camera 102 having a zoom lens assembly. The zoom lens assembly allows the first camera 102 to selectively adjust its focal length across a range of focal lengths. When a camera or lens assembly is discussed herein as having a particular “35 mm equivalent focal length,” this camera or lens assembly has a focal length that produces the same angle of view as another camera or lens assembly that has a 35 mm sensor and a focal length equal to the specified 35 mm equivalent focal length. In other words, a first camera having a 100 mm equivalent focal length has an angle of view that is the same as that of a second camera with a 35 mm sensor and a 100 mm focal length, but the first camera need not have a 100 mm focal length. Accordingly, the first camera 102 is able to selectively adjust its focal length to achieve a range of different 35 mm equivalent focal lengths.

In some instances, the first camera 102 is part of a multi-camera system. For example, in the variation shown in FIG. 1A, the first camera 102 is part of a multi-camera system having a second camera 104, and a third camera 106. The second camera 104 and/or third camera 106 may have a 35 mm equivalent focal length (or a range of 35 mm equivalent focal lengths) that does not overlap the range of 35 mm equivalent focal lengths of the first camera 102. For example, in some variations the shortest 35 mm equivalent focal length achievable by the first camera 102 is longer than the 35 mm equivalent focal length (or ranges of 35 mm equivalent focal lengths) of the second camera 104 and the third camera 106. It should be appreciated that the device 100 may include a single camera, or a multi-camera system having any number of cameras (with any relative positioning) as may be desired. Additionally, while shown as placed on the rear of a device 100, it should be appreciated that a camera having a zoom lens assembly may be additionally or alternatively placed on the front (e.g., a front side having a display) or any other side of the device as desired.

In some instances, the device 100 may include a flash module 108. The flash module 108 may provide illumination to some or all of the fields of view of the cameras of the device (e.g., the fields of view of the first camera 102, the second camera 104, and/or the third camera 106). This may assist with image capture operations in low light settings. Additionally or alternatively, the device 100 may further include a depth sensor 110 that may calculate depth information for a portion of the environment around the device 100. Specifically, the depth sensor 110 may calculate depth information within a field of coverage (i.e., the widest lateral extent to which the depth sensor is capable of providing depth information). The field of coverage of the depth sensor 110 may at least partially overlap the field of view of one or more of the cameras (e.g., the fields of view of the first camera 102, second camera 104, and/or third camera 106). The depth sensor 110 may be any suitable system that is capable of calculating the distance between the depth sensor 110 and various points in the environment around the device 100.

The depth information may be calculated in any suitable manner. In one non-limiting example, a depth sensor may utilize stereo imaging, in which two images are taken from different positions, and the distance (disparity) between corresponding pixels in the two images may be used to calculate depth information. In another example, a depth sensor may utilize structured light imaging, whereby the depth sensor may image a scene while projecting a known pattern (typically using infrared illumination) toward the scene, and then may look at how the pattern is distorted by the scene to calculate depth information. In still another example, a depth sensor may utilize time of flight sensing, which calculates depth based on the amount of time it takes for light (typically infrared) emitted from the depth sensor to return from the scene. A time-of-flight depth sensor may utilize direct time of flight or indirect time of flight, and may illuminate an entire field of coverage at one time, or may only illuminate a subset of the field of coverage at a given time (e.g., via one or more spots, stripes, or other patterns that may either be fixed or may be scanned across the field of coverage). In instances where a depth sensor utilizes infrared illumination, this infrared illumination may be utilized in a range of ambient conditions without being perceived by a user.

In some embodiments, the device 100 is a portable multifunction electronic device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer, which may have a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content by transmitting, via a wired or wireless connection, data (e.g., image data or video data) to an integrated or external display generation component to visually produce the content.

FIG. 1B depicts exemplary components of the device 100. In some embodiments, device 100 has a bus 126 that operatively couples I/O section 134 with one or more computer processors 136 and memory 138. I/O section 134 can be connected to display 128, which can have touch-sensitive component 130 and, optionally, intensity sensor 132 (e.g., contact intensity sensor). In addition, I/O section 134 can be connected with communication unit 140 for receiving application and operating system data, using Wi-Fi, Bluetooth, near field communication (NFC), cellular, and/or other wireless communication techniques. The device 100 can include input mechanisms 142 and/or 144. Input mechanism 142 is, optionally, a rotatable input device or a depressible and rotatable input device, for example. Input mechanism 142 is, optionally, a button, in some examples. The device 100 optionally includes various sensors, such as GPS sensor 146, accelerometer 148, directional sensor 150 (e.g., compass), gyroscope 152, motion sensor 154, and/or a combination thereof, all of which can be operatively connected to I/O section 134. Some of these sensors, such as accelerometer 148 and gyroscope 152 may assist in determining an orientation of the device 100 or a portion thereof.

Memory 138 of the device 100 can include one or more non-transitory computer-readable storage mediums, for storing computer-executable instructions, which, when executed by one or more computer processors 136, for example, can cause the computer processors to perform the techniques that are described here (such as actuating the zoom lens assemblies described herein). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The processor 136 can include, for example, dedicated hardware as defined herein, a computing device as defined herein, a processor, a microprocessor, a programmable logic array (PLA), a programmable array logic (PAL), a generic array logic (GAL), a complex programmable logic device (CPLD), an application-specific integrated circuit (ASIC), a field-programmable gate array (FPGA), or any other programmable logic device (PLD) configurable to execute an operating system and applications of device 100, as well as to facilitate setting a field of view of a camera and capturing of images as described herein. Device 100 is not limited to the components and configuration of FIG. 1B, but can include other or additional components in multiple configurations.

FIG. 1C illustrates components of the first camera 102 of the device 100 of FIG. 1A. The first camera 102 includes a zoom lens assembly 112, an image sensor 114, a set of actuators including a first actuator 116A and a second actuator 116B, and a controller 118. The zoom lens assembly 112 includes a plurality of lens groups, specifically a first lens group 120A, a second lens group 120B, and a third lens group 120C. The first lens group 120A is positioned to receive light 122 entering the camera 102 from the environment (e.g., emitted and/or reflected from the scene surrounding the camera 102), redirect the light 122 along an optical axis 124 of the zoom lens assembly 112, and directs the light 122 along the optical axis 124 to the second lens group 120B. The second lens group 120B directs the light 122 along the optical axis 124 to the third lens group 120C, which in turn passes the light 122 to the image sensor 114. Each lens group includes one or more lens elements (e.g., made from glass, plastic, or the like) that are configured to receive and refract light along the optical axis 124. Specifically the first lens group 120A includes a first set of lens elements, the second lens group 120B includes a second set of lens elements, and the third lens group 120C includes a third set of lens elements.

The second lens group 120B and third lens group 120C are independently moveable relative to the first lens group 120A along the optical axis 124 to adjust the focal length of the zoom lens assembly 112. Specifically, the first actuator 116A is configured to move the third lens group 120C along the optical axis 124. Similarly, the second actuator 116B is configured to move the second lens group 120B along the optical axis 124. The actuators described here may include any suitable actuator suitable for moving a lens element or lens group within a camera, such as a stepped motor, a voice coil motor actuator, a piezoelectric actuator, a leaf spring actuator, combinations thereof, and the like. To change the focal length of the zoom lens assembly 112, the controller 118 selectively controls the first actuator 116A and the second actuator 116B to move the second lens group 120B and the third lens group 120C along the optical axis 124. To adjust the focus of the zoom lens assembly 112, the controller controls the first actuator 116A to move the third lens group 120C along the optical axis 124 while controlling the second actuator 116B to maintain a position of the second lens group 120B. Specifically, the third lens group 120C may be moved toward the image sensor 114 to move focus toward a minimum focus distance of the zoom lens assembly 112, and may be moved away from the image sensor to move the focus toward infinity.

In some variations, the set of actuators may further include a third actuator 116C that is configured to move a light-folding element of the first lens group 120A. In these instances, the third actuator 116C may rotate or tilt the light-folding element relative to the second lens group 120B and the third lens group 120C, as well as the remaining lens elements of the first lens group 120A. This rotation may be used to provide optical image stabilization of the camera 102. Specifically, the controller 118 may control the third actuator 116C to rotate and/or tilt the prism in response to camera motion (e.g., as sensed by a motion sensor, accelerometer, gyroscope, combinations thereof, or the like) to provide optical image stabilization of images captured by the first camera 102.

FIG. 2A shows a variation of a camera 200 having zoom lens assembly 202 and image sensor 204 as described herein. The zoom lens assembly 202 provides variable magnification capabilities to the camera 200, and includes a first lens group 206A, a second lens group 206B, and a third lens group 206C. The second lens group 206B and third lens group 206C are moveable relative to each other along an optical axis of the camera 200 and relative to the first lens group 206A (e.g., using a set of actuators as described previously) to change the magnification of the zoom lens assembly 202 as described previously. While lens groups described herein may be moveable within a camera, it should be appreciated that each lens group includes one or more lens elements that are fixed relative to each other.

Specifically, the zoom lens assembly 202 may be controlled to vary the focal length of the zoom lens assembly 202 within a focal range. The focal range includes a minimum focal length and a maximum focal length. In some of the embodiment described herein, the focal range spans a range that includes at least 35 mm equivalent focal lengths of 72 mm and 108 mm (which in turn allows the camera to provide a range of magnifications spanning at least 3× to 4.5× magnifications). In some of these embodiments, the minimum focal length (expressed in 35 mm equivalent focal length) is 72 mm, and the maximum focal length (expressed in 35 mm equivalent focal length) is 108 mm. In some variations, the focal range spans a range that includes at least 35 mm equivalent focal lengths of 72 mm and 120 mm (which in turn allows the camera to provide a range of magnifications spanning at least 3× to 5× magnifications). In some of these embodiments, the minimum focal length (expressed in 35 mm equivalent focal length) is 72 mm, and the maximum focal length (expressed in 35 mm equivalent focal length) is 120 mm.

When the zoom lens assembly 202 is moved across the focal range (i.e., between the minimum and maximum focal lengths), the f number of the lens assembly 202 may also vary. The f number, which refers to the ratio between the focal length and the diameter of an entrance aperture of the lens assembly 202, may in some instances be less than or equal to f/3.0 across the entire focal range of the zoom lens assembly 202. For example, in some variations (such as when the focal range is between 72 mm and 108 mm in 35 mm equivalent focal lengths), the zoom lens assembly 202 has an f number value between f/2.2 and f/2.9 across the focal range. In other variations (such as when the focal range is between 72 mm and 108 mm in 35 mm equivalent focal lengths), the zoom lens assembly 202 has an f number value between f/2.2 and f/3.0 across the focal range.

In some embodiments, such as that shown in FIG. 2A, the first lens group 206A is immediately adjacent to the second lens group 206B along the optical axis, and the second lens group 206B is immediately adjacent to the third lens group 206C. Similarly, the third lens group 206C may be immediately adjacent to the image sensor 204. When a lens element or lens group is described herein as being “immediately adjacent” to another component, this refers to the lens element or lens group being positioned relative to the other component such that there are no intervening lens elements (though there may be other components, such as an aperture layer or portions of an actuator, positioned at least partially therebetween).

In some embodiments, the first lens group 206A has negative refractive power, the second lens group 206B has positive refractive power, and the third lens group 206C has negative refractive power. The first lens group 206A includes a light-folding element 208 that receives light at an object side of the lens assembly, and redirects the light onto the optical axis of the zoom lens assembly 202. While shown in FIG. 2A as being a prism, the light-folding element 208 may alternatively be configured as a mirror or other structure capable of redirecting light onto the optical axis of the zoom lens assembly 202.

In some instances, the first lens group 206A includes a plurality of lens elements positioned between the light-folding element 208 and the second lens group 206B, and that are fixed along the optical axis of the camera 200. For example, the first lens group may include a first lens element 210 positioned immediately adjacent the light-folding element 208 and having positive refractive power. In instances where the light-folding element 208 is also fixed relative to the camera 200 (i.e., the light-folding element 208 is not rotated or tilted to provide optical image stabilization as discussed above), a surface of the first lens element 210 may be placed in contact with a corresponding surface of the light-folding element 208 (e.g., a prism surface in instances where the light-folding element 208 is configured as a prism).

The first lens group 206A further includes at least one negative power lens element (i.e., having negative refractive power), between the first lens element 210 and the second lens group 206B. For example, in the variation shown in FIG. 2B, the first lens group 206A includes a second lens element 212 and a third lens element 214. The second lens element 212 and the third lens element 214 are positioned such that the second lens element 212 is positioned between the first lens element 210 and the third lens element 214. In the variation shown in FIG. 2A, the second lens element 212 has positive refractive power and the third lens element 214 has negative refractive power. In other variations, the second lens element 212 has negative refractive power and the third lens element 214 has negative refractive power.

The second lens group 206B includes at least one lens element having positive refractive power. In some of these variations, the second lens group 206B includes a plurality of lens elements that includes at least one lens element with positive refractive power and at least one lens element with negative refractive power. For example, the variation of second lens group 206B shown in FIG. 2A includes a first lens element 218 having positive refractive power, a second lens element 220 having positive refractive power, and a third lens element 222 having negative refractive power. In these variations, the second lens group 206B is configured such that the second lens element 220 is positioned between the first lens element 218 and the third lens element 222, and the third lens element 222 is positioned between the second lens element 220 and the third lens group 206C. In other variations, the second lens group 206B may include only two lens elements: a first lens element having positive refractive power and a second lens element having negative refractive, such that the second lens element is positioned between the first lens element and the third lens group 206C.

Additionally, in some variations the second lens group 206B includes an aperture layer 216 that defines an aperture that encircles an optical axis of the zoom lens assembly 202. The aperture layer 216 may be positioned between the first lens group 206A and at least a portion of every lens element of the second lens group 206B and the first lens group 206A. For example, in the variation shown in FIG. 2A the aperture layer 216 is positioned at least partially between the first lens element 218 and the first lens group 206A. In some instances, at least a portion of the first lens element 218 extends through the aperture defined by the aperture layer 216, though it should be appreciated that the aperture layer 216 is positioned such that the first lens element 218 does not extend at least partially through the aperture defined by the aperture layer 216.

The third lens group 206C includes a first lens element 224 having positive refractive power and a second lens element 226 having negative refractive power. The third lens group 206C is configured such that the first lens element 224 is positioned between the second lens element 226 and the second lens group 206B (which positions the second lens element 226 between the first lens element 224 and the image sensor 204). In some instances, the first lens element 224 of the third lens group 206C has a relatively large thickness compared to the other lens elements of the zoom lens assembly 202. For example, in some variations the first lens element 224 of the third lens group 206C has a thickness ratio greater than 0.10, where the thickness ratio is defined as the ratio of the thickness D of a lens element to the total optical stack length TTL of the zoom lens assembly 202. The total optical stack length TTL is the distance between the image side of the first lens element 210 of the first lens group 206A (i.e., the side facing the light-folding element 208) and the image plane of the zoom lens assembly (which coincides with the positioning of the image sensor 204 in FIG. 2A).

In some instances, the thickness ratio of the first lens element 224 of the third lens group 206C is greater than or equal to 0.15. In one non-limiting example, the total optical stack length TTL is 20 mm, and the thickness of first lens element 210 of the first lens group 206A is greater than 3 mm (e.g., such as when the focal range is between 72 mm and 108 mm in 35 mm equivalent focal lengths). In still other embodiments, the thickness ratio of the first lens element 224 of the third lens group 206C is greater than or equal to 0.18, such as in instances when the focal range is between 72 mm and 120 mm in 35 mm equivalent focal lengths.

As mentioned above, the second lens group 206B and third lens group 206C are moveable to change the focal length of, and magnification provided by, the zoom lens assembly 202. For example, FIG. 2B shows the camera 200 with the zoom lens assembly 202 in a first configuration in which the second lens group 206B and the third lens group 206C are positioned to provide the minimum focal length of the zoom lens assembly's focus range. By moving both the second lens group 206B and the third lens group 206C toward the first lens group, such as the configuration shown in FIG. 2C, the zoom lens assembly 202 may be positioned to provide an intermediate focal length of the zoom lens assembly's focus range. Continuing to move the second lens group 206B and the third lens group 206C toward the first lens group 206A will place the zoom lens assembly 202 in a configuration, as shown in FIG. 2D, in which the second lens group 206B and the third lens group 206C are positioned to provide the maximum focal length of the zoom lens assembly's focus range. It should be appreciated that the second lens group 206B and the third lens group 206C may move different distances when changing the zoom lens assembly between different configurations to provide different magnifications. Additionally, while the zoom lens assembly 202 is in a given configuration to provide a target magnification level, the third lens group 206C may be moved while the second lens group 206B is held in the same position to adjust the focus level of the zoom lens assembly as discussed previously.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. A camera comprising:
an image sensor;
a lens assembly having an optical axis and comprising:
a first lens group having negative refractive power and comprising a first set of lens elements that is fixed in position on the optical axis;
a second lens group moveable along the optical axis between the first lens group and the image sensor, having positive refractive power, and comprising a second set of lens elements; and
a third lens group moveable along the optical axis between the first lens group and the image sensor, having negative refractive power, and comprising a third set of lens elements; and
a set of actuators; and
a controller, wherein:
the controller is configured to control the set of actuators to move the second lens group and the third lens group along the optical axis to set a focal length of the lens assembly within a focal range of the lens assembly.

2. The camera of claim 1, wherein the controller is configured to control the set of actuators to move the third lens group along the optical axis while maintaining a position of the second lens group to focus the camera.

3. The camera of claim 1, wherein the first lens group comprises a light-folding element configured to receive light from an object side of the lens assembly and redirect the light along the optical axis.

4. The camera of claim 3, wherein the first set of lens elements comprises a first lens element positioned immediately adjacent the light-folding element.

5. The camera of claim 1, wherein an f-number of the lens assembly is less than or equal to 3.0 across the focal range.

6. The camera of claim 5, wherein the f-number of the lens assembly is between f/2.2 and f/3.0 across the focal range.

7. The camera of claim 1, wherein the focal range includes at least a range of 35 mm equivalent focal lengths between 72 mm and 108 mm.

8. A camera comprising:
an image sensor; and
a lens assembly having an optical axis and comprising:
a first lens group having negative refractive power and comprising a first set of lens elements that is fixed in position on the optical axis;
a second lens group immediately adjacent the first lens group, moveable along the optical axis, having positive refractive power, and comprising a second set of lens elements; and
a third lens group immediately adjacent the first lens group, moveable along the optical axis, having negative refractive power, and comprising a third set of lens elements.

9. The camera of claim 8, wherein:
the first lens group comprises a light-folding element configured to receive light from an object side of the lens assembly and redirect the light along the optical axis; and
the first set of lens elements comprises a first lens element positioned immediately adjacent the light-folding element.

10. The camera of claim 9, wherein:
the first set of lens elements comprises a second lens element immediately adjacent to the first lens element of the first set of lens elements;
the first set of lens elements comprises a third lens element immediately adjacent to the second lens element of the first set of lens elements; and
the third lens element has negative refractive power.

11. The camera of claim 8, wherein:
the second set of lens elements comprises a first lens element having positive refractive power and a second lens element having negative refractive power.

12. The camera of claim 11, wherein:
the first lens element of the second set of lens elements is immediately adjacent the first lens group.

13. The camera of claim 12, wherein:
the second lens group comprises an aperture layer defining an aperture.

14. The camera of claim 13, wherein the aperture layer is positioned between the first set of lens elements and the second set of lens elements.

15. A lens assembly having an optical axis comprising:
a first lens group having negative refractive power;
a second lens group moveable along the optical axis and having positive refractive power; and
a third lens group moveable along the optical axis and having negative refractive power, wherein:
the first lens group comprises a light-folding element and a first lens element having positive refractive power and fixed in position on the optical axis;
the second lens group comprises a first lens element having positive refractive power and immediately adjacent the first lens group; and
the third lens group comprises a first lens element having positive refractive power and immediately adjacent the second lens group.

16. The lens assembly of claim 15, wherein a thickness ratio of the first lens element of the third lens group is greater than 0.10, wherein the thickness ratio is a ratio of a thickness of the first lens element to a total optical stack length of the lens assembly.

17. The lens assembly of claim 16, wherein the thickness ratio of the first lens element of the third lens group is greater than or equal to 0.15.

18. The lens assembly of claim 15, wherein:
the third lens group comprises a second lens element having negative refractive power; and
the first lens element of the third lens group is positioned between the second lens element of the third lens group and the second lens group.

19. The lens assembly of claim 15, wherein:
the second lens group comprises an aperture layer defining an aperture.

20. The lens assembly of claim 19, wherein the aperture layer is positioned between the first set of lens elements and the second set of lens elements.
